(19) United States
(12) Patent Application Publication
(10) Pub. No.: US 2003/0211304 A1
(43) Pub. Date: Nov. 13, 2003

(54) Molded finished part and method of making same cross-references to related applications

(76) Inventors: Kenneth Assink, Holland, MI (US); Dennis J. Beard, Holland, MI (US); Thomas L. Boerema, Jenison, MI (US); Russell L. Clark, Jenison, MI (US); Teresa M. Donnay Heger, Holland, MI (US); Curt A. Herrington, Jenison, MI (US); Alan L. Kindig, Holland, MI (US)

Correspondence Address: James E Bartek, 56th Street, Grandville, MI, 49418, US

(21) Appl. No.: 10/220,093

(22) PCT Filed: Mar. 30, 2001
(86) PCT No.: PCT/US01/10262

(51) Int. Cl. B32B 7/08

(52) U.S. Cl. 428/221; 428/223

(57) ABSTRACT

A molded finished part includes a finish insert (172) with a finish disposed upon a front insert side and a body portion of the molded part. The insert (172) has a substantially rigid yet resilient layer of moldable material. The layer has opposing front and back insert sides. The part body portion has a body surface that corresponds to the back insert side. The body portion is also formed of moldable material. Further, the body surface and the back insert side are melded together in a substantially indistinguishable interface.

### CROSS-REFERENCES TO RELATED APPLICATIONS

This is a continuing non-provisional application of co-pending U.S. provisional Patent Application Serial No. 60/193,196, entitled Molded Finished Part and Method of Making and filed on Mar. 30, 2000, the disclosure of which is incorporated here by reference.

### STATEMENT REGARDING FEDERALLY SPONSORED RESEARCH OR DEVELOPMENT

Not Applicable.

### BACKGROUND OF THE INVENTION

The invention relates to molding a part that is in a finished or ready to assemble condition with a finish material covering at least one side of the part. The finish material may commonly be a fabric material, for example. Fabric materials may include without limitation, woven and non-woven textile fabrics. The finish material may also include membrane materials, for example. Membrane materials may include without limitation, plastic or metallic films.

One having ordinary skill in the art will know that various attempts have been made and are being marketed for molding a part with a fabric or other decorative finished surface, commonly known as back molding, known as reverse molding, in mold lamination, and hinterspritzen. These prior attempts at back molding a part have had various degrees of success with various sheet good finish materials. Generally, these prior attempts at back molding basically involve draping a flexible sheet of finish material across a mold die, closing the die and injection molding a part The finish material will have two opposing sides with one of these sides being preselected to be an exposed finish surface. A molten moldable material is injected into the closed mold on the other or back side of the finish material.

Use of textile or fabric materials has commonly had bleed through problems. That is, the molten moldable material that is injected behind the fabric permeates the fabric finish material and leaks through the material to the exposed finish surface, which is unacceptable. Alternatively, membrane materials are commonly subject to thermal damage. The heat of the molten material that is injected behind the membrane may cause the membrane to melt. Both of these issues may be seen to relate to flow control of the injected molten material and temperature control of both the injected molten material and the mold.

Even without regard to the bleed through and heat problems, distortion problems may be considered inherent in the back mold process. If the finish material has a pattern on the finish side surface, then that pattern will stretch and shift when the finish material is pressed against the mold as the moldable material flows behind the finish material and into the mold cavity.

Thus, while back molding holds very attractive possibilities for enhancing the production of finished part molding, there remain significant limitations as briefly noted above.

### BRIEF SUMMARY OF THE INVENTION

Accordingly, a molded finished part of the invention and a method of making same address the deficiencies previously known in back molding. More particularly, the invention provides a back mold insert or finish insert that substantially lines at least a portion of a part mold with a finish material surface generally abutting the mold cavity surface. Thus, the finish surface is placed in substantially final position at the beginning. Also, the finish insert preferably has a back surface, opposite to the finish surface, that is compatible with the moldable material that is used to make the part, so the back mold insert will naturally or inherently become integral with the part. The insert may also define a barrier to the moldable material penetrating through the finish surface.

The molded finished part preferably includes a finish insert with a finish disposed upon a front insert side and includes a body portion of the molded part. The insert has a substantially rigid yet resilient layer of a moldable material The layer further has opposing front and back insert sides. The part body portion has a body surface that corresponds to the back insert side. The body portion is also formed of moldable material. Further, the body surface and the back insert side are melded together in a substantially indistinguishable interface.

The molded finished part may be formed by a process that comprises providing a mold, providing an insert, positioning the insert in the mold, then closing the mold, injecting a moldable material into the mold cavity, opening the mold, and removing the molded part. The insert is a resilient member and has opposing insert front and back sides. The mold cavity includes at least a first cavity surface and the insert front side includes an insert front surface that corresponds to the first cavity surface. The insert front surface engages the first cavity surface when the finish insert is positioned in the mold cavity. Also, the moldable material flows against the insert back side and the insert front surface is pressed against the first cavity surface.

These and other features, objects, and benefits of the invention will be recognized by one having ordinary skill in the art and by those who practice the invention, from this disclosure, including the specification, the claims, and the drawing figures.

### BRIEF DESCRIPTION OF THE SEVERAL VIEWS OF THE DRAWING

FIG. 1 is a perspective view of a fabrication line that is adapted to fabricate finish inserts of the invention;

FIG. 2 is a fragmentary cross-sectional schematic view of a finish insert;

FIG. 3 is an exploded fragmentary cross-sectional schematic view of an number of strata of materials for a finish insert;

FIG. 4 is the view of FIG. 3, showing a first alternative construction of a finish insert;

FIG. 5 is the view of FIG. 3, showing a second alternative construction of a finish insert, including a rigid structure;

FIG. 6 is the view of FIG. 2, showing the second alternative construction of FIG. 5 incorporated in a finish insert;

FIG. 7 is a cross-sectional schematic view of a finish insert mold in a closing condition;

FIG. 8 is the view of FIG. 7 in a closed position;

FIG. 9 is an enlarged view of detail IX of FIG. 7;

FIG. 10 is an enlarged view of detail X of FIG. 8;

FIG. 11 is a schematic representation in perspective view of a finish insert bladder wrap mold;

FIG. 12 is an enlarged fragmentary cross-sectional view thereof showing the mold closed;

FIG. 13 is an enlarged fragmentary schematic representation in cross-sectional view of a trim fixture with a finish insert;

FIG. 14 is an exploded schematic representation of a back mold in cross-sectional view, showing positioning of a finish insert;

FIG. 15 is an enlarged view of detail XV of FIG. 14;

FIG. 16 is the view of FIG. 14, showing the finish insert positioned relative to one side of the back mold;

FIG. 17 is an enlarged view of detail XVII of FIG. 16;

FIG. 18 is a schematic representation of a back mold in cross-sectional view, showing the finish insert positioned with the back mold closed;

FIG. 19 is an enlarged view of detail XIX of FIG. 18;

FIG. 20 is similar to the view of FIG. 17, showing a first alternative mold and insert.

### DETAILED DESCRIPTION OF THE INVENTION

A molded finished part of the invention is an item that is molded and that has a finish material that is exposed as a finished exterior surface of at least a portion of an exterior of the item A molded finished part of the invention may be formed with any of various configurations and from numerous constructions, as may be dictated by the specific requirements for the part or by the preferences of a user or manufacturer, for example, as will be understood by one having ordinary skill in the art. The finish material may commonly be a fabric material or flexible membrane, for example, which may include without limitation, woven and non-woven textile fabrics. Alternatively, the finish material may also include membrane materials, for example, which may include without limitation, plastic or metallic films.

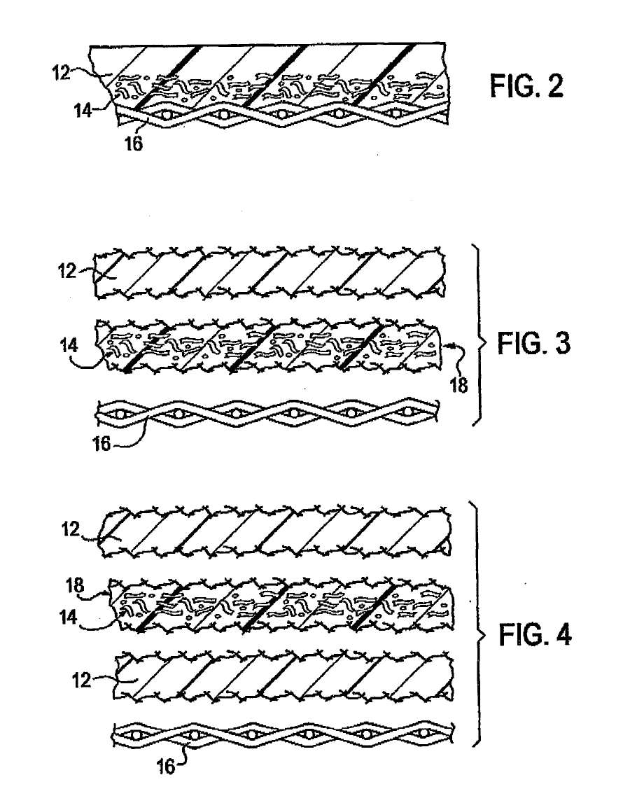

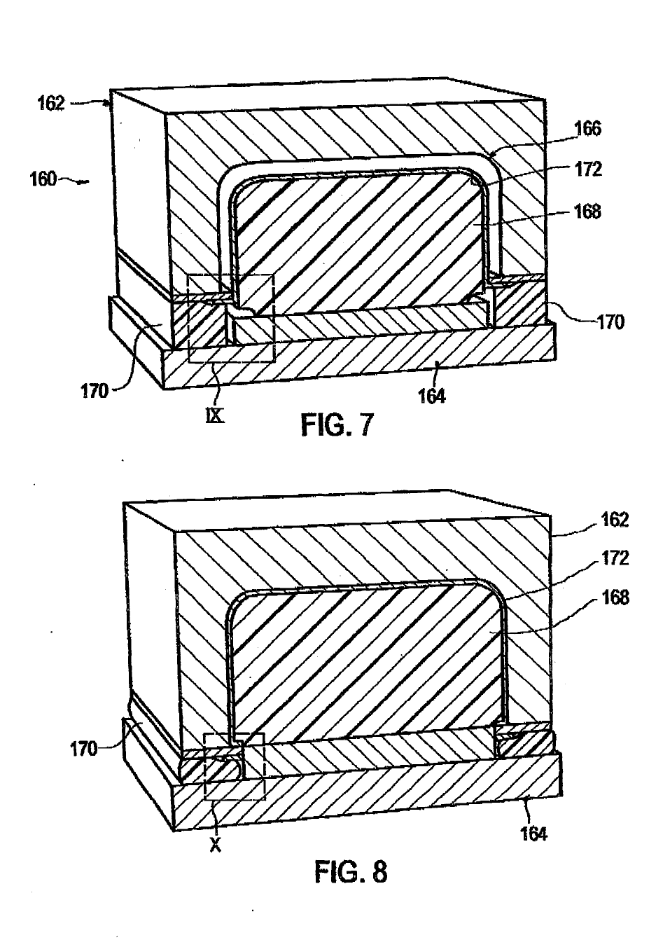

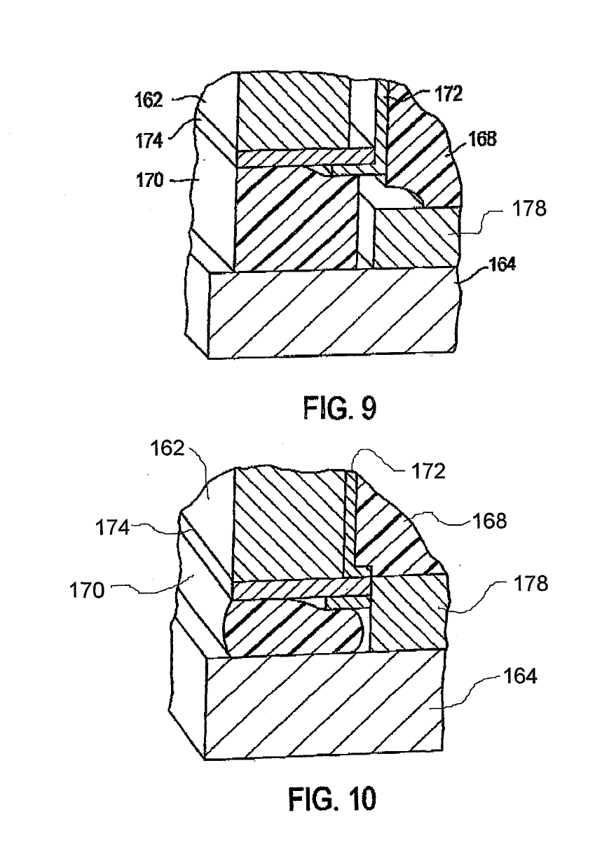

A molded finished part of the invention is formed by back molding, reverse molding, in mold laminating, or hinterspritzen, which are known to one having ordinary skill in the art, a finish insert 172 (FIGS. 7-16). The insert 172 may also be a molded member and is most preferably a substantially rigid and yet resilient member. Being a rigid member, the insert 172 will not significantly deform or displace during the back molding process. In a preferred embodiment, the back mold insert 172 may be a unified or monolithic member that has a layer of moldable material 12 and a finish material 16, and may optionally also include a stratum of a filler material 14 (FIG. 2). The moldable material layer 12 has two opposing surfaces, namely, a finish surface or front insert side and a back surface. The finish material 16 is at least partially imbedded into the finish surface and defines a finish side of the back mold insert 172. While the front insert side is entirely a finish surface as shown, a particular use of the invention may call for an insert in which the finish surface is only a portion of the front insert side. Also, the stratum of a filler material 14 may optionally be embedded in the moldable material layer 12 as is further discussed below.

The layer 12 of moldable material may be fabricated of a single material or a blend of component materials. The preferred materials for the moldable material layer 12 may be thermoplastics, including, and not limited to, polyester, co-polyester, polypropylene, nylon, polyethylene, or blends thereof When a blend of materials is used, one of the component materials may have a higher melting point than the others and provide a matrix to which lower melting point materials may bond. This matrix material may also include thermoplastics as given by example above, and may also include natural materials such as, sisal, cotton, flax, hemp, ceramic filaments, and metal filaments, for example. One having ordinary skill in the art will know that the use of an all polyester composition may provide a relatively more freely flowing base material that will conform to tight radius mold shapes and that other resulting insert characteristics may be preselected by the composition of the layer of moldable material.

The layer 12 may be preferably provided as a non-woven mat. Re-cycled or virgin polyester or polypropylene or mixes thereof, for example, may be chopped, shredded, carded, blended and lofted into a non-woven sheet and the sheet gathered for storage and handling on a roll, as is known. In the blending process, a homogenous mixture of material may be provided according to predetermined desired resulting properties.

The finish insert 172 may be successfully constructed and used with a single mat of material, as one having ordinary skill in the art will understand. The one will further understand that a predetermined combination of multiple component mats that have different preselected compositions will result in an insert 172 that has a customized structure characteristics, according to a user's requirements. Thus, a second mat 18 comprised of a blend including the filler material 14, for example, may be used with the mat 12 to introduce and position a stratum of filler material 14 into the resulting monolithic finish insert 172 of the invention (FIGS. 2 and 3). This may be conveniently accomplished by the same procedure that is used to provide the layer 12 of moldable material discussed above, except that fibers of filler material are included in the blend. Thus, the second mat 18 of a homogeneous mixture of moldable material and filler material 14 is also provided according to predetermined desired resulting properties. The filler materials may include any of various materials that preferably have a melting point temperature that is higher than that of the moldable material that is used to mold the finish insert 172. Some exemplary materials that may be used as filler include, without limitation, polyester, polypropylene, nylon, polyethylene, ceramics, metals, sisal, cotton, flax, and hemp.

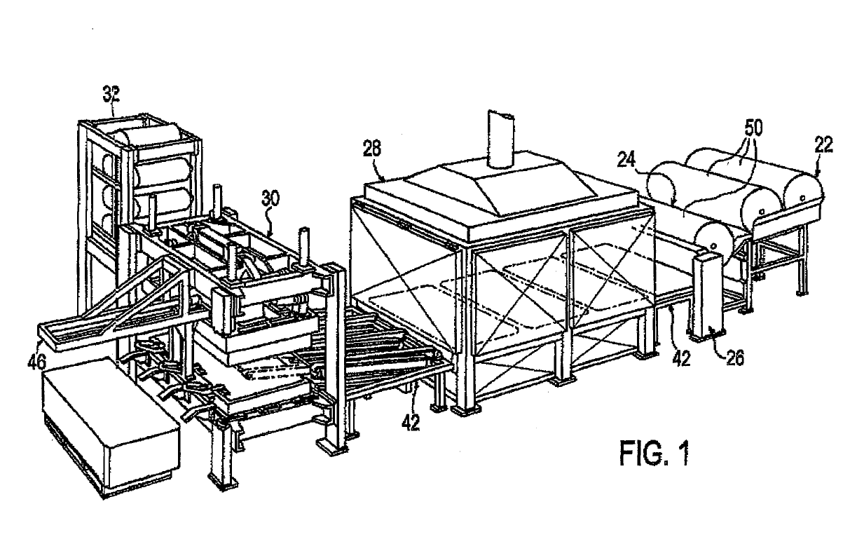

As shown in the drawing FIG. 1, a fabrication line that is configured to fabricate finish inserts of the invention may include a load station 22, an uncoiler 24, a shear 26, a high intensity oven 28, a bonding press 30, and a fabric carousel 32. The press 30 may be provided with cooperating mold halves or dies 162 and 164 (FIGS. 7-10) that define a mold cavity 166 with a predetermined configuration, so the press will form a desired, pre-determined finish insert 172 when the mold halves 162 and 164 are mated.

A first conveyor portion 42 may interconnect the loading station 22, the uncoiler 24, the shear 26, the high intensity oven 28, and the bonding press 30 (FIG. 1). A second conveyor portion may interconnect the fabric carousel 32 and the bonding press 30. Further, an automatic unloader 46 may be provided to remove inserts 172 from the bonding press 30 and stack them on a pallet or transfer them to another conveyor, for example.

The first mat 12 of moldable material and the second mat 18, which includes the filler 14, may be provided on separate rolls 50 at the load station 22 or may be concentrically rolled on the same roll. Either way, when the finish insert 172 is to be constructed with an embedded stratum, the two mats 12 and 18 are aligned and simultaneously feed through the shear 26. The mats 12 and 18 are cut at a predetermined length by the shear 26 and feed by the conveyer portion 42 into the oven 28. Of course, when the insert 172 is to be constructed with a homogenous structure, rather than positioning a stratum of material within the unified member, only one mat 12 of blended material may be used. Again, each mat 12 and 18 may be designed to provide desired characteristics according to the materials blended into the mat, while a resulting finish insert may be designed to provide desired characteristics by blending mats of differing composition in a predetermined array.

The moldable material in the mat 12, and the mat 18 if desired, is preferably heated in the oven 28 to a point of transition from a solid state to a moldable state, which may be a gel-like or even partially liquid state of the material. Some of the fibers of moldable material may liquefy in the oven while others remain solid and yet others may be in a transition or gel-like condition. As discussed above, a matrix material with a relatively higher melting point may also be include. Thus, the material becomes very soft and can still be handled because it retains the mat structure. The hot mats 12 and 18 are further transferred by conveyer portion 42 from the oven 28 to the bonding press 30.

Substantially simultaneously, or previously, a corresponding piece of finish material or fabric 16 is transferred from the fabric carousel 32 to the bonding press 30 by the second conveyor portion, and the fabric is mated with the hot mats 12 and 18. The finish material or fabric 16 may commonly be a fabric material, including without limitation, woven and non-woven textile fabrics. The finish material 16 may also include membrane materials, including without limitation, plastic or metallic films.

The fabric 16 and the hot mats 12 and 18 are aligned with one another and the mold, and the press 30 is closed, which captures and presses the finish fabric 16 and the mats 12 and 18 between the mold halves 162 and 164. The hot moldable material may fully transition to the liquid material state in the mold because of pressure applied by the press 30. Regardless, the hot moldable material moves or flows within the mold of press 30. Thus, the two mats 12 and 18 become one layer with a stratum of filler 14 embedded and positioned in the moldable material according to the array of mats. Generally throughout the mold cavity, the molten moldable material may be pressed and flow, attaching to any non-molten material. The molten material is also pressed into the finish fabric 16, so the fabric becomes at least partially embedded into the moldable material.

The mold halves or dies 162 and 164 are most preferably temperature controlled below the melting temperature of the moldable material. Thus, the oven heats the moldable material and the pressure of the closed mold in the press shapes the material before transfer of heat from the material to the dies sets the material in a solid state.

Structural characteristics of the resulting finish insert may be influenced by the material make up, as discussed above, and by the method of construction, including such factors as closed mold temperature and pressure, and material densities, among other factors. More specifically, for a given amount of material, a given mold cavity volume will result in a particular material density. By holding the mold cavity constant, an increase in the amount of material will increase the resulting material density. A resulting finish insert with a relatively higher resulting material density will be a relatively tougher insert that resists puncturing, including the insertion of pins and the like. Alternatively, a decrease in the amount of material will produce a finish insert with a relatively lower resulting material density, and will be less tough, that is more susceptible to the insertion of pins, resulting in a tackable finish insert if desired.

Thus, a finish insert 172 of the invention can be a fully tackable, for example, by adjusting the resulting material density appropriately. That is to say that the finish insert 172 may be constructed so a paper or the like may be posted or tacked anywhere on the insert with a pushpin or tack or the like. As a mater of geometry, a tackable finish insert 172 will preferably have an at least three eighths inch (10 mm) thickness to support a weighted push-pin, as one having ordinary skill in the art will understand.

One may also note that when the moldable material is heated to a liquid state, the material may commonly be quite viscous and may not flow freely, running throughout the mold cavity. Rather, the molten moldable material may tend to remain at the location where it was placed when the press closes the mold, although localized mold pressures may cause some movement or ooze. Thus, the finish insert may have localized areas of relatively higher material density, and associated greater material toughness, where the mold cavity and the resulting insert 172 cross-sectional thickness is thinner, for example.

Further depending upon the requirements of a particular molded finish part, a fire barrier may be desired in the finish insert 172. This may be implemented with a stratum 14 of fiberglass or a layer of foil under the finish fabric 16, for example. A mat 18 (FIG. 3) that uses fiberglass as the filler material and has a relatively high ratio blend of fiberglass to moldable material may provide an acceptable level of fire barrier characteristic. Alternatively, a foil may be layered under the finish fabric, as if another mat.

As discussed above, one having ordinary skill in the art will realize that a finish insert 172 of the invention may be constructed by various alternative ‘lay-ups’ arrays of multiple mats prior to molding them in the bonding press into a monolithic finish insert 172 of the invention. By selecting different numbers of mats and by changing the thickness and content of each mat, that is by preselecting a particular array of mats, one may alter the stiffness, toughness, sound, and other characteristics of a resulting monolithic finish insert 172 of the invention.

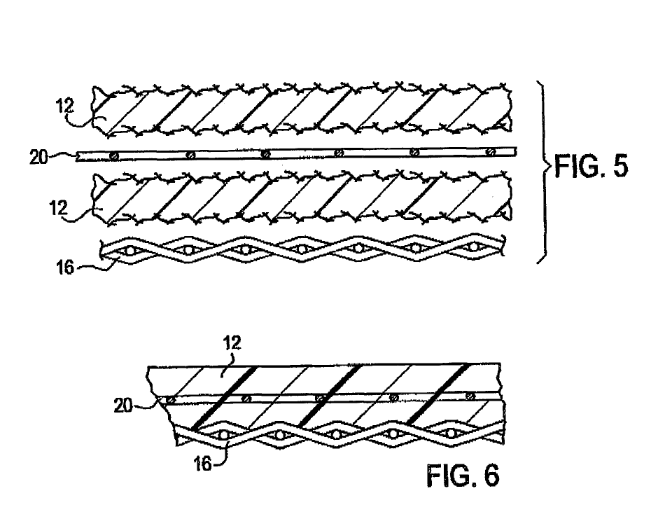

A lay-up of fabric 16, a filler blend mat 18, and a moldable material mat 12 (FIG. 3) will produce a unified finish insert 172 with an embedded filler stratum 14 adjacent the fabric 16 (FIG. 2), for example. Alternatively, the embedded filler stratum 14 may be spaced from the fabric 16, if desired, by using an additional moldable material mat 12 (FIG. 4) or by reversing the placement of the mats 12 and 18, for example. Alternatively, strength and other characteristics may be enhanced with the use of metal or ceramic fibers, for example. Further, a rigid structure, including without limitation a metal mesh 20, may be embedded in the unified insert 172 by including the structure in the mat array (FIGS. 5 and 6).

More specifically, the finish insert 172 may be formed in a mold 160 of various commonly known constructions. A preferred mold configuration is generally shown in drawing FIGS. 7-10. This mold has upper and lower mold halves 162 and 164, respectively. The upper half 162 is generally shown as a female mold portion with a mold cavity 166 that has a predetermined configuration, as discussed above. The lower mold half 164 is generally shown as a male mold portion with a silicone core 168 and soft compression members 170, as are understood by one having ordinary skill in the art. When the mold 160 closes, the combination of the finish material 16 and hot mat, which may include strata 12 or 12 an 14, for example, of moldable material, and the combination of which are generally referred to as the finish insert 172, are captured between the mold halves 162 and 164. More particularly, a perimeter edge of the finish insert 172 is captured and clamped between the upper half 162 and the soft members 170.

A plate-like member 174 extends generally inward from a lower edge of the upper mold half 162. As the mold 160 fully closes, the core 168 squishes, fills the cavity 166, and presses the composite 172 into conforming with the cavity 166. Further, the core 168 presses generally outward over the member 174 and forms an inward extending flange 176 at the perimeter edge of the finish insert 172. By providing a very close tolerance between the plate-like member 174 of the upper mold half 162 and a block-like member 178 of the lower mold half 164, a shear is defined within the mold 160 and along perimeter flange 176. Thus, configuration molding of the finish insert 172 and final trimming are accomplished in one step of the finish insert molding operation. The finish insert 172 may be flexed to remove it from the cavity 166 of upper mold half 162 if required. Alternatively, the member 174 may include a slide or series of slides that translated laterally and release the finish insert 172, as is known by one having ordinary skill in the art.

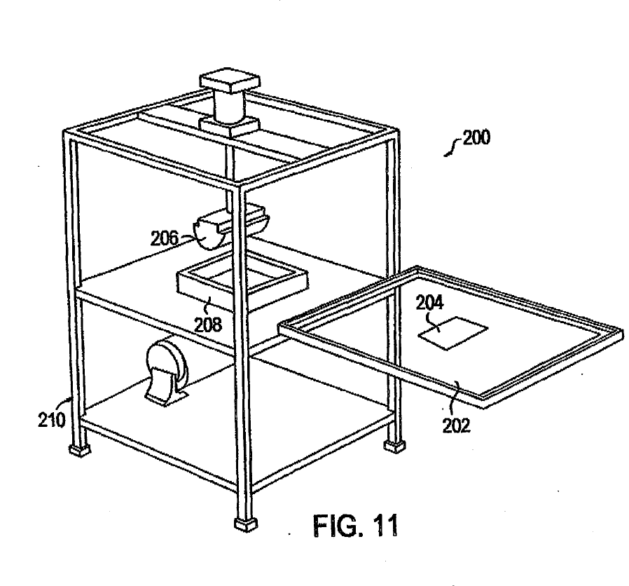

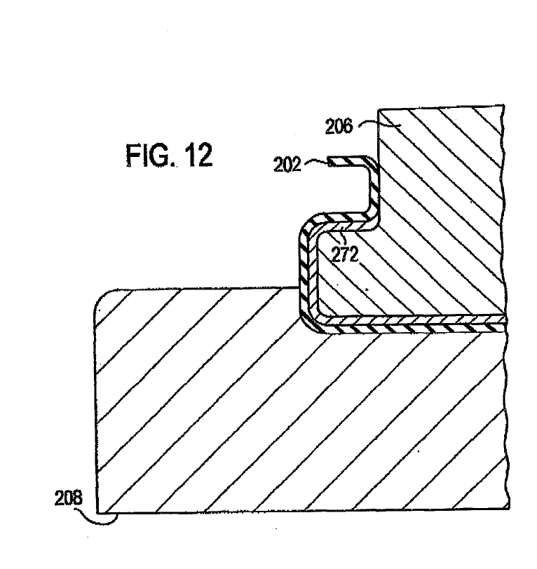

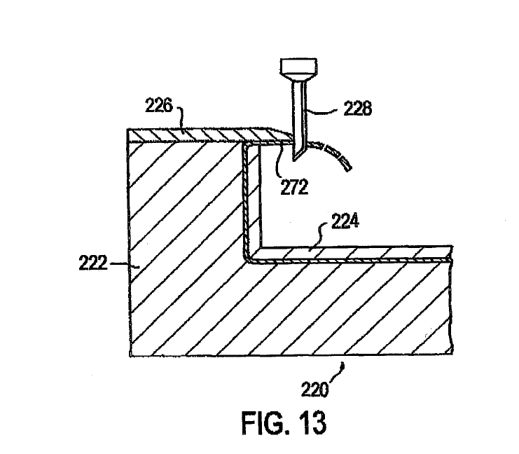

Various molding methods may be used to form the finish insert 172. The use of the mold 160, discussed above is a preferred yet exemplary method. A more traditional match mold may also be used to form a back mold insert 172. The preferred molding method of forming the insert 172 may be influenced by several factors, including and not limited to, the specific part requirements or specifications and the preferred technology of the manufacturer. Another preferred and exemplary molding of the back mold insert is generally shown in FIGS. 11-13, in which a two hundred series of reference numbers are used to indicate a second embodiment. Thus, while the first embodiment of the insert, discussed above, is identified by reference number 172, the second embodiment of the insert, discussed below, is identified by reference number 272 and the different numbering primarily distinguishes between two forming methods.

The back mold insert 272 is formed in a bladder wrap mold 200 (FIG. 11), which includes a frame 210, a resilient bladder 202 with a blank 204, a horn 206, and a nest 208, as are understood by one having ordinary skill in the art. Accordingly, a heated mat 12 and finish material 16, which are discussed in greater detail above are positioned between the horn 206 and the bladder 202 or blank 204. The mold 200 closes onto the raw insert 272 by extending the horn 206 against the mat 12 and into the nest 208 (FIG. 12). This causes the bladder to at least partially wrap around the raw insert 272 and in turn at least partially wrap the insert 272 around the horn 206. A suction is drawn on the mold, that draws the bladder 202 and the inset 272 fully around the horn 206, as is understood by one having ordinary skill in the art. Thus, the insert 272 may be substantially vacuum formed in the bladder wrap mold 200.

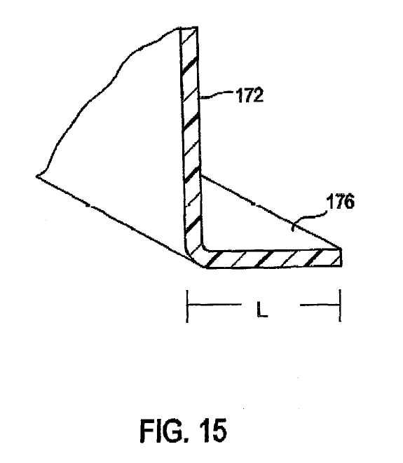

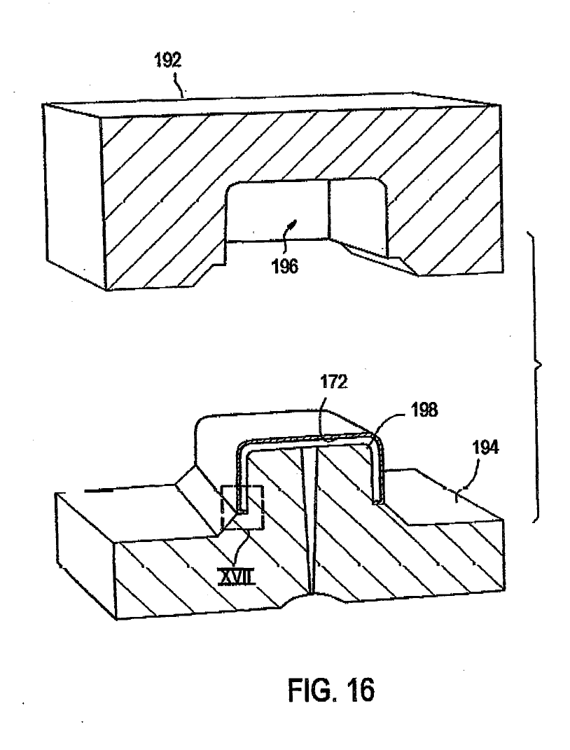

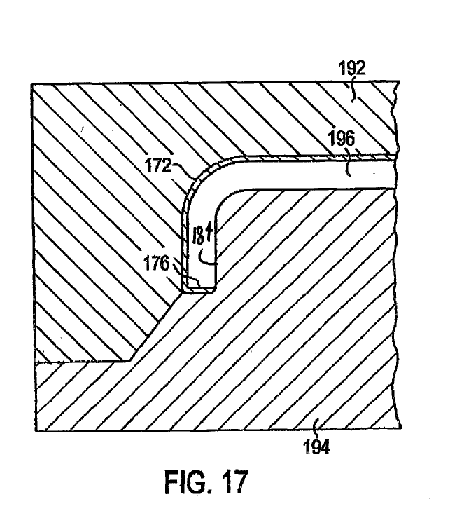

The finish insert 272 may be pealed from or otherwise removed from the horn 206 and positioned in a trim fixture 220 (FIG. 13). The trim fixture 220 may include a trim nest 222, a trim clamp 224, a trim guide 226, and a trim knife 228. It is also noted that the insert 172 may also be formed without being trimmed in the mold 160 and then be trimmed in a trim fixture 220 or the like. Thus, either the insert 272 or an untrimmed insert 172 will be understood to be included interchangeably by reference to either the insert 172 or 272 as follows. The insert 172 or 272 may be seated in the trim nest 222 and held in position with the trim clamp 224. The trim guide 226 may be positioned or indexed to trim a flange 176 of the insert 172 as desired by running a knife device 228 along the guide. The guide 226 may provide additional support to the insert 172 during trimming and the knife device 228 may be heated to facilitate cutting, both as will be understood by one having ordinary skill in the art. More specifically, the flange is preferably trimmed to a length “L” (FIG. 15) so the flange is tight to an injection mold without deflection, as will be discussed further below.

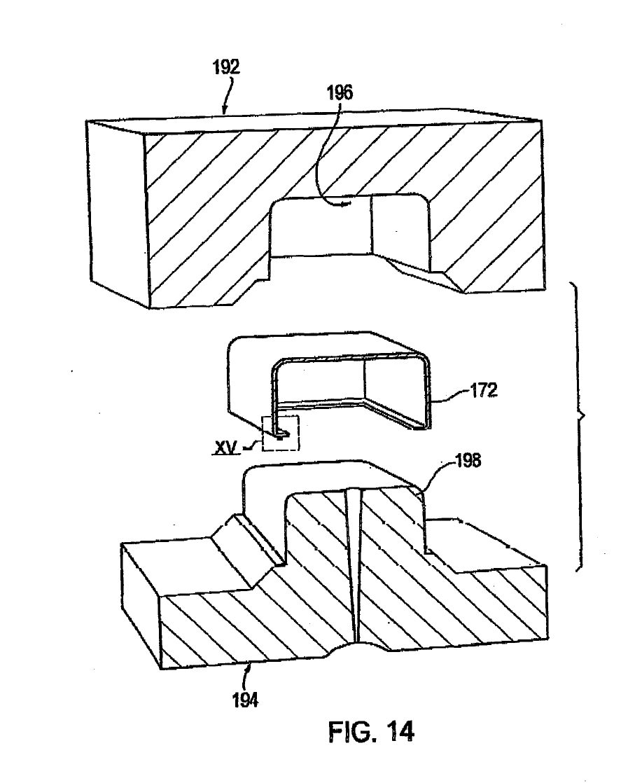

Preferably, a trimmed back mold insert 172 is positioned in an injection mold 190 (FIGS. 11-16). The mold 190 may have upper and lower mold halves 192 and 194, respectively. The upper mold half 192 may be a female mold half and preferably have a mold cavity 196 that corresponds to the finish or front side of the insert 172 so the insert mates with or seats into the mold cavity 196 in substantially abutting engagement. Thus, the finish insert 172 will conform to and effectively line the cavity 196. The lower mold half 194 may then be a male mold half with a core portion 198 (FIGS. 14 and 16-19). The finish insert 172 may be fit over the core 198 and the mold closed. Alternatively, the finish insert 172 may be seated in the cavity 196 and the mold closed with the core 198 then seating within the finish insert.

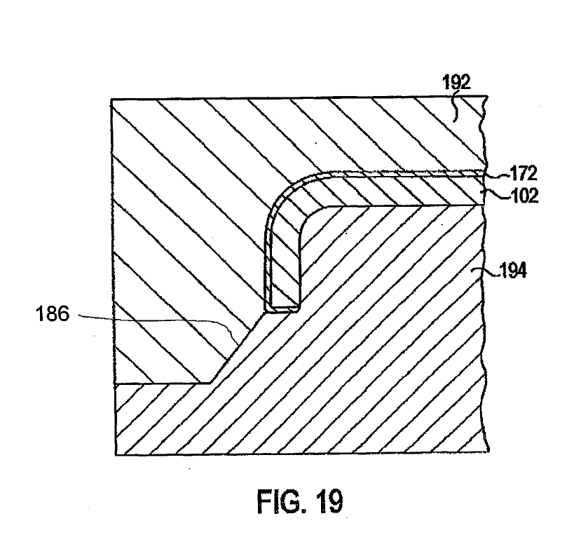

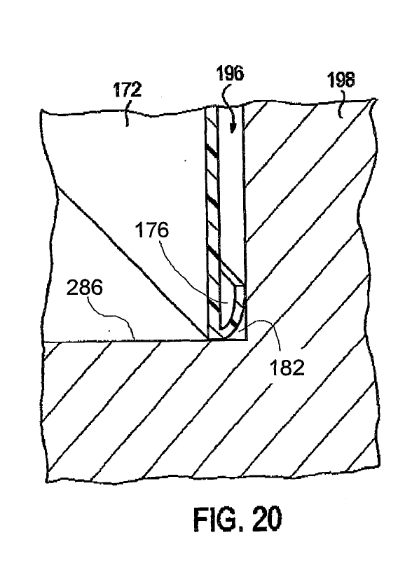

With the finish insert 172 positioned between the upper and lower mold halves 192 and 194, respectively, and the mold closed, a moldable material 102 may be injected into the mold cavity, through a passage or runner 180, as is commonly known by one having ordinary skill in the art (FIGS. 18 and 19). The moldable material 102. may include thermoplastics such as polyester, copolyester, polypropylene, nylon, polyethylene, or blends thereof, for example. More particular to back molding, the hot moldable material 102 is injected on one side of the finish insert 172, namely, the unfinished back side. Because the insert 172 is formed of a moldable material arid preferably a material that is compatible with the molten moldable material 102, the insert and the resulting molded part may become a unitary piece. The insert back side and the injected material 102 meld together in a substantially indistinguishable interface.

As shown and discussed, the hot moldable material 102 is injected between the finish insert 172 and the core 198 and substantially becomes a body portion of or actually the finished molded part itself. While the moldable material 102 is injected, it flows through the mold cavity 196 between the finish insert 172 and the core 198 and presses the finish insert 172 against and to some extend along the surface of the upper mold half 192, which the finish insert abuts and lines (FIGS. 14 and 16-19). Thus, the finish material 16 may also creep along the surface of the upper mold half 192. Depending upon factors that may include the size of the part and the elasticity or stretch of the finish material 16, the material may creep a distance so the finish material will not only wrap over an edge of the finished molded part, but may further creep and wrap around to and overlay a portion of a back of the molded part.

In many parts, it is desirable to have the finish surface or material wrap around an edge of the part. Thus, it may be important that the edge 176 define an exterior surface of the part and not become embedded in the molten moldable material that will be the finished molded part. For at least this reason, the flange 176 is preferably trimmed to a length “L” (FIG. 15) so the flange is not deflected by the mold core 198 as noted above. While a small deflection may be allowable, a no deflection condition is preferred because this will more likely avoid an excessive deflection condition, which could occur in common production tolerances. Deflection of the flange 176 is undesirable because an excessive deflection is likely to result in the injected molten moldable material passing the terminal edge of the flange 176 and filling a void 182 that is formed behind the deflected flange (FIG. 20). This occurrence may be referred to as blow by.

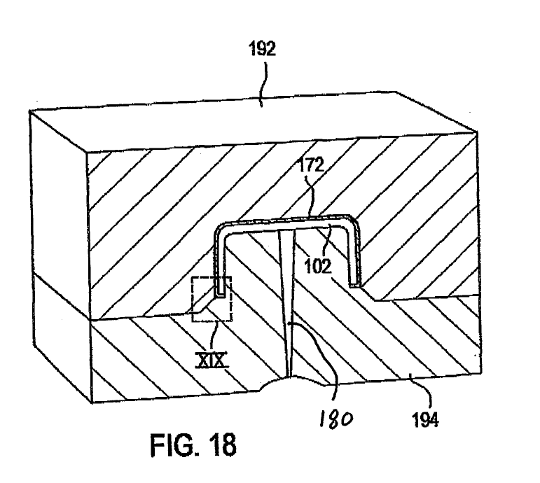

When the injected moldable material passes the flange 176 and fills the void 182, the flange becomes embedded into the body of the molded part and does not provide a finish surface that wraps around the edge of the molded part. Proper sizing of the length “L” of the flange 176 may be given by the thickness of the edge of the molded part. More specifically, while the insert 172 abuts one surface of the mold cavity, specifically the inner surface of the upper mold half 192 as shown, the insert is spaced away from an opposing surface 184 (FIG. 17), the inner surface of the lower mold half 194. This spacing defines a thickness of the molded part. At the insert flange 176, the part thickness and the flange length “L” may most preferably be the same.

Because the finish insert 172 may creep along the surface of the upper mold half 192 as discussed above, the length “L” of the flange 176 may actually be less than the thickness of the molded part and still provide satisfactory covering of the finished molded part. For example, if the molded part thickness is about 5/16 inch (8 mm) the flange length “L” may be as short as about 3/16 inch (5 mm) and still be pressed by the flow of the injected molten material 102 and creep to fully cover the edge of the part.

The resulting molded part has a finished surface as provided by the finish insert 172 and also has a finished, trimmed edge as predetermined by the selected trim length of the flange 176 in the forming of the finish insert as discussed above. It is also noted that by appropriate thermal control methods as are known to one having ordinary skill in the art, the upper mold half 192 and the finish surface of the finish insert may be maintained at a preselected cool temperature while the molten moldable material 102 is injected into the cavity 196 between the finish insert 172 and the core 198. Further, heat transfer between the hot moldable material 102 and the unfinished side of the finish insert 172 may cause some softening or melting of the unfinished or back surface of the insert with a result of the finish insert and the injected moldable material melding together and the resulting molded finish part being a monolithic or unitary member.

It is further noted that the angle of the parting line 186 (FIG. 19) and 286 (FIG. 20) between the upper and lower mold halves 192 and 194, respectively, may affect the creep of the finish material 16 and the resulting wrap or coverage of the finish material around the molded part edge. With the parting line 186 extending at an angle from the insert 127, relative to the flange 176, the insert or finish material 16 is free to creep and extend around the edge of the finished molded part. With the parting line 286 extending generally straight out from the insert 127, relative to the flange 176, the insert or finish material 16 may be captured and restricted from creeping and extending around the edge of the finished molded part.

It will be understood by one having ordinary skill in, the art and by those who practice the invention, that various modifications and improvements may be made without departing from the spirit of the disclosed concept. An improvement that is within the scope of the disclosed concept may include, without limitation, the embedding of various conduits, electrical, pneumatic, or hydraulic, for example, within a unified finish insert of the invention. Various relational terms, including left, right, front, back, top, and bottom, for example, are used in the detailed description of the invention and in the claims only to convey relative positioning of various elements of the claimed invention The scope of protection afforded is to be determined by the claims and by the breadth of interpretation allowed by law.

I claim:

1 A molded part with a finished surface comprising:
a back molding finish insert, the insert having a substantially rigid yet resilient layer of a first moldable material, the layer having opposing first and second insert sides, and a finish disposed upon the first insert side; and
a body portion of the molded part, the body portion having at least a first body surface that corresponds to the second insert side, the body portion being formed of a second moldable material, the first and the second moldable materials being mutually compatible whereby the first body surface and the second insert side are melded together in a substantially indistinguishable interface.

2 A process of fabricating a molded part with a finished surface comprising the steps of:
providing a mold, the mold defining a mold cavity, the mold cavity corresponding to a predetermined part configuration, the mold cavity including at least a first cavity surface, the first cavity surface corresponding to a finished surface of the molded part;
providing a finish insert, the finish insert being a substantially rigid and resilient member, the finish insert having opposing insert front and back sides, the insert front side including a finished surface, the finished surface corresponding to the first cavity surface;
positioning the finish insert into the mold with the finished surface engaging the first cavity surface;
closing the mold with the finish insert positioned in the mold cavity;
injecting a moldable material into the mold cavity whereby the moldable material flows against the insert back side, the insert front side thereby being pressed against the first cavity surface;
opening the mold; and
removing the molded part from the mold.

3 A process of claim 2 wherein the step of providing the finish insert further includes forming the finish insert of a moldable material.

4 A process of fabricating a molded part with a finished surface comprising the steps of:
providing a mold, the mold defining a mold cavity, the mold cavity being adapted to form a predetermined molded part, the mold cavity including at least a first cavity surface;
providing an insert, the insert being a resilient member, the insert having opposing insert front and back sides, the insert front side including an insert front surface that corresponds to the first cavity surface;
positioning the insert into the mold with the insert front surface engaging the first cavity surface;
then closing the mold with the finish insert so positioned in the mold cavity;
injecting a moldable material into the mold cavity so the moldable material flows against the insert back side and the insert front surface presses against the first cavity surface;
opening the mold; and
removing the molded part from the mold.

5 A process of claim 2 wherein the step of providing the finish insert further includes forming the finish insert of a moldable material.
